(19) United States
(12) Patent Application Publication
(10) Pub. No.: US 2007/0159856 A1
(43) Pub. Date: Jul. 12, 2007

(54) Flyback power converter with split primary winding transformer

(76) Inventor: Ta-Yung Yang, Milpitas, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/329,136

(22) Filed: Jan. 11, 2006

(51) Int. Cl. H02M 3/335

(52) U.S. Cl. 363/21.12

(57) ABSTRACT

A flyback power converter includes a transformer having a first primary winding and a second primary winding. The first primary winding is coupled to the positive supply rail. The second primary winding is coupled to the negative supply rail. A transistor is connected in between the first primary winding and the second primary winding for switching the transformer. A control circuit is coupled to the transistor and the second primary winding to generate a switching signal for switching the transistor and regulating the output of the flyback power converter. A supplied capacitor is connected to the control circuit to supply the power to the control circuit. The second primary winding has a leakage inductor to store a stored energy when the transistor is on. A diode is coupled from the negative supply rail to the supplied capacitor. The stored energy of the leakage inductor is discharged to the supplied capacitor through the diode once the transistor is off. The split primary winding of the transformer improves the efficiency and reduces the EMI.

### BACKGROUND OF THE INVENTION

1. Field of the Invention

The present invention relates to a switching power converter, and more specifically relates to a flyback power converter.

2. Description of Related Art

Power converters are widely used to provide regulated voltage and current. Considerable ongoing research is focused on making power converters more efficient for saving power. A power converter typically includes a control circuit, a transistor and a transformer. The control circuit is applied to sense the output voltage and/or the output current of the power converter, and generate a control signal to control the transistor and regulate the output voltage and/or the output current of the power converter.

FIG. 1 shows a circuit diagram of a traditional flyback power converter. A transformer 10 includes a primary winding N_{P}, a secondary winding N_{S} and an auxiliary winding N_{A.} A terminal of the primary winding N_{P} is coupled to a positive supply rail V_{IN}. A transistor 11 is connected from another terminal of the primary winding N_{P} to a negative supply rail (a ground) through a resistor 12. A control circuit 25 is coupled to the transistor 11 to control the transistor 11 for switching the transformer 10 and regulating the output voltage and/or the output current of the flyback power converter. A terminal of the secondary winding N_{S} connects a rectifier 13. A filter capacitor 14 is coupled between the rectifier 13 and another terminal of the secondary winding N_{S}. Energy is stored into the transformer 10 when the transistor 11 is turned on. The energy stored in the transformer 10 is discharged to the output of the flyback power converter through the secondary winding N_{S} once the transistor 11 is off. Meanwhile, a reflected voltage V_{AUX} is generated at the auxiliary winding N_{A} of the transformer 10.

$$\begin{matrix}{V}_{O} + {V}_{F} = {N}_{NS} \times \frac{ⅆ Φ}{ⅆ t} & ( 1 ) \\ {V}_{AUX} = {N}_{NA} \times \frac{ⅆ Φ}{ⅆ t} & ( 2 )\end{matrix}$$

In accordance with equations (1) and (2), the reflected voltage V_{AUX} can be expressed as

$${V}_{AUX} = \frac{{N}_{NA}}{{N}_{NS}} \times ( {V}_{O} + {V}_{F} ) \qquad ( 3 )$$

where N_{NA} and N_{NS} are respectively the winding turns of the auxiliary winding N_{A} and the secondary winding N_{S} of the transformer 10; V_{O} is the output voltage of the flyback power converter; V_{F} is a forward voltage drop of the rectifier 13; the Φ is magnetic flux,
Φ=B×Aₑ (B is flux density, Ae is the core cross-section of the transformer 10).

The control circuit 25 comprises a supply terminal VDD and a ground terminal GND for receiving power. A divider includes a resistor 15 and a resistor 16 connected between the auxiliary winding N_{A} of the transformer 10 and the negative supply rail. A voltage detection terminal VS of the control circuit 25 is connected to a joint of the resistor 15 and the resistor 16. A detecting voltage V_{DET1} generated at the voltage detection terminal VS is given by,

$${V}_{DET 1} = \frac{{R}_{16}}{{R}_{15} + {R}_{16}} {V}_{AUX} \qquad ( 4 )$$

where R₁₅ and R₁₆ are respectively the resistance of the resistors 15 and 16.

The reflected voltage V_{AUX} further charges a supplied capacitor 17 via a diode 18 to power the control circuit 25. The resistor 12 serves as a current sense device. The resistor 12 is connected from the transistor 11 to the negative supply rail for converting the transformer switching current I_{P} into a current signal V_{CS}. A current sense terminal VI of the control circuit 25 is connected to the resistor 12 for detecting the current signal V_{CS}. An output terminal VG of the control circuit 25 generates a switching signal V_{PWM} to switch the transformer 10. Although this flyback power converter is able to regulate output voltage and output current, but it has several drawbacks. One drawback is high power consumption caused by the leakage inductor of the transformer 10. A snubber circuit includes a snubber diode 19, a snubber capacitor 20 and a snubber resistor 21 to consume the stored energy of the leakage inductor of the transformer 10 for protecting the transistor 11 from a high voltage spike. Another drawback of this flyback power converter is a poor load regulation at light load and no load. The power of the control circuit 25 is supplied from the auxiliary winding N_{A} of the transformer 10. Therefore, the operating current of the control circuit 25 represents the load of the auxiliary winding N_{A}. If the load at the output voltage V_{O} of the flyback power converter is lower than the load consumed by the auxiliary winding N_{A}, then the stored energy of the transformer 10 will only be discharged to the supplied capacitor 17 through the diode 18 and the auxiliary winding N_{A}. The rectifier 13 will remain off when the transistor 11 is turned off. Therefore, the output voltage V_{O} of the flyback power converter cannot be feedback through the auxiliary winding N_{A}. The detecting voltage V_{DET1} generated at the voltage detection terminal VS is only related to the voltage of the supply terminal VDD at light load and no load situations.

Another prior art is “Primary-side controlled flyback power converter” by Yang, et al; U.S. Pat. No. 6,853,563. One principal drawback of this prior-art invention is the EMI (electric and magnetic interference). The drain terminal of the transistor is directly connected to the positive supply rail V_{IN}. A parasitic capacitor of the transistor and a parasitic inductor coupled together form a high frequency resonant tank, which produces higher EMI.

The object of the present invention is to provide a flyback power converter having high efficiency and low EMI. Besides, the output voltage of the flyback power converter can be accurately regulated at light load and no load.

### SUMMARY OF THE INVENTION

A flyback power converter includes a transformer having a first primary winding and a second primary winding. The first primary winding is coupled to a positive supply rail. The second primary winding is coupled to a negative supply rail. A transistor is connected in between the first primary winding and the second primary winding for switching the transformer. A current sense device is connected from the transistor to the second primary winding for generating a current signal in accordance with a switching current of the transformer. A control circuit is coupled to the transistor and the second primary winding of the transformer to generate a switching signal in response to the current signal. The switching signal is used for switching the transistor and regulating the output of the flyback power converter. A supplied capacitor is connected to the control circuit to supply the power to the control circuit. The second primary winding has a leakage inductor to store a stored energy when the transistor is on. A diode is coupled from the negative supply rail to the supplied capacitor. The stored energy of the leakage inductor is discharged to the supplied capacitor through the diode once the transistor is off. The split primary winding of the transformer improves the efficiency and reduces the EMI.

It is to be understood that both the foregoing general descriptions and the following detailed descriptions are exemplary, and are intended to provide further explanation of the invention as claimed. Still further objects and advantages will become apparent from a consideration of the ensuing description and drawings.

### BRIEF DESCRIPTION OF THE DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a circuit diagram of a traditional flyback power converter;

FIG. 2 shows a circuit diagram of a flyback power converter according to one embodiment of the present invention;

FIG. 3 shows an equivalent circuit diagram of the flyback power converter shown in FIG. 2; and

FIG. 4 shows a circuit diagram of a control circuit according to one embodiment of the present invention.

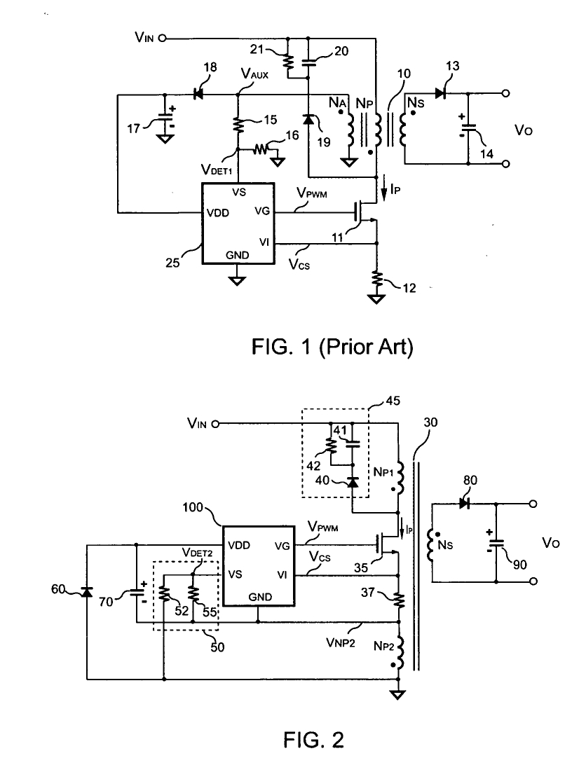

### DESCRIPTION OF THE PREFERRED EMBODIMENTS

FIG. 2 shows a circuit diagram of a flyback power converter in accordance with the present invention. The flyback power converter includes a transformer 30 for transferring a stored energy from a primary side of the transformer 30 to a secondary side of the transformer 30. The primary side of the transformer 30 has a first primary winding N_{P1}, and a second primary winding N_{P2}. The secondary side of the transformer 30 has a secondary winding N_{S}. The first primary winding N_{P1} is coupled to the positive supply rail V_{IN} of the transformer 30. The second primary winding N_{P2} is coupled to the negative supply rail (ground) of the transformer 30. A transistor 35 is connected in between the first primary winding N_{P1} and the second primary winding N_{P2} for switching the transformer 30. The transistor 35 can be a power transistor or a power MOSFET. Because the transistor 35 is connected in between the first primary winding N_{P1} and the second primary winding N_{P2}, the high frequency resonant tank caused by the parasitic devices is eliminated and also the EMI is reduced.

A current sense device such as a current sense resistor 37 is connected from the transistor 35 to the second primary winding N_{P2} for generating a current signal V_{CS} in accordance with the switching current I_{P} of the transformer 30. In order to regulate an output voltage V_{O} of the flyback power converter, a control circuit 100 is coupled to the transistor 35 and the second primary winding N_{P2} of the transformer 30 to generate a switching signal V_{PWM}. The switching signal V_{PWM} is used for switching the transistor 35 and regulating the output voltage V_{O} of the flyback power converter. A supplied capacitor 70 is connected to the control circuit 100 to supply the power to the control circuit 100. A diode 60 is coupled between the supplied capacitor 70 and the negative supply rail of the transformer 30.

A snubber circuit 45 is coupled between the first primary winding N_{P1} and the positive supply rail V_{IN}. The snubber circuit 45 includes a snubber diode 40, a snubber capacitor 41 and a snubber resistor 42. A terminal of the snubber diode 40 is coupled to the first primary winding N_{P1} and the transistor 35. The snubber capacitor 41 is coupled between another terminal of the snubber diode 40 and the positive supply rail V_{IN}. The snubber resistor 42 is coupled in parallel with the snubber capacitor 41. A divider 50 is coupled between the second primary winding N_{P2} and the negative supply rail. The divider 50 includes resistors 52 and 55. The resistor 52 is coupled between the control circuit 100 and the negative supply rail. The resistor 55 is coupled between the resistor 52 and the second primary winding N_{P2}. A rectifier 80 is coupled to the secondary winding N_{S}. A filter capacitor 90 is coupled between the secondary winding N_{S} and the rectifier 80.

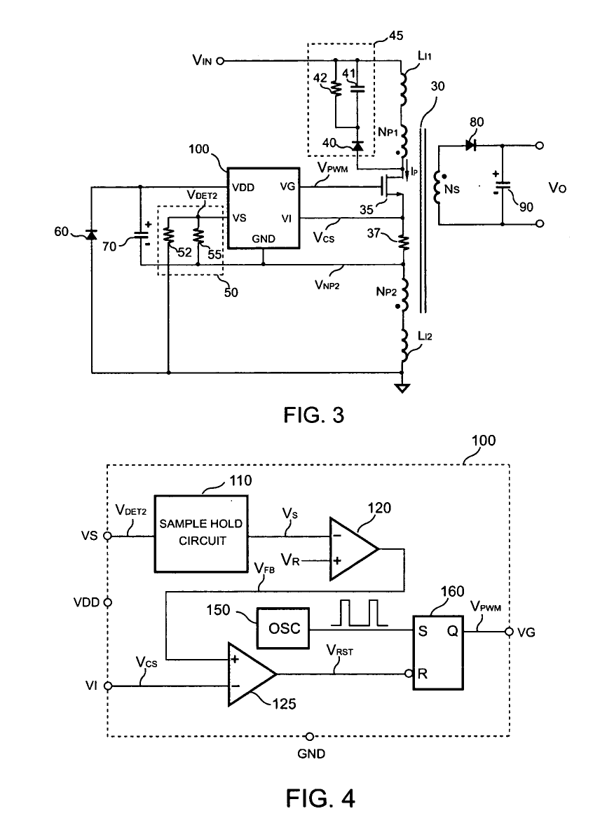

FIG. 3 shows an equivalent circuit diagram of the flyback power converter shown in FIG. 2. The first primary winding N_{P1} and the second primary winding N_{P2} include leakage inductors L₁₁ and L₁₂ respectively. Due to the geometrical structure of the transformer, the stored energy of the primary side winding of the transformer cannot be fully transferred to other windings of the transformer. The leakage inductors L₁₁ and L₁₂ stand for stored energy that cannot be transferred. The switching current I_{P} is flowed into the transformer 30 when the transistor 35 is turned on. The energy is thus stored into the transformer 30 and leakage inductors L₁₁ and L₁₂. When the transistor 35 is turned off, the stored energy of the transformer 30 is discharged to the secondary winding N_{S}. Meanwhile the stored energy of the leakage inductors L₁₁ and L₁₂ will be circulated within the loop. If the loop is blocked, a voltage spike will be produced.

$$V = L \times \frac{ⅆ i}{ⅆ t} \qquad ( 5 )$$

The snubber circuit 45 is used to consume the stored energy of the leakage inductor L₁₁ for protecting the transistor 35 from a high voltage spike. The power consumed by the snubber resistor 42 of the snubber circuit 45 can be shown as,

$${P}_{R} = \frac{{V}_{R 42}^{2}}{{R}_{42}} = \frac{1}{2} \times {L}_{l} \times {I}_{P}^{2} \times fsw \qquad ( 6 )$$

where R₄₂ is the resistance of the snubber resistor 42; V_{R42} is the voltage across the snubber resistor 42; L₁ is the inductance of the leakage inductor L₁₁; f_{SW} is the switching frequency of the transistor 35.

Therefore, reducing the inductance of the leakage inductor of the transformer 30 will increase the efficiency of the flyback power converter. However, in order to meet the safety requirement, the winding of the transformer 30 always produces a significant leakage inductance. A simple way to reduce the leakage inductance is to reduce the winding turns.

$$L = μ \times \frac{0.4 π \times A e}{li} \times {N}^{2} \qquad ( 7 )$$

where L is the inductance; μ is core permeability; li is magnetic path length; N is the number of winding turns; Ae is the core cross-section of the transformer 30.

Splitting the primary winding of the transformer 30 to the first primary winding N_{P1} and the second primary winding N_{P2} can reduce the winding turns so that the leakage inductance in the first primary winding N_{P1} is reduced. The stored energy of the leakage inductor L₁₂ is discharged to the supplied capacitor 70 through the diode 60 once the transistor 35 is off. Therefore, the stored energy of the leakage inductor L₁₂ is supplied to the control circuit 100. The voltage V_{DD} generated in the supplied capacitor 70 can be shown as

$${V}_{DD} = [ \frac{{N}_{NP 2}}{{N}_{NS}} \times ( {V}_{O} + {V}_{F} ) ] + {V}_{L l2} \qquad ( 8 )$$

where N_{NP2} and N_{NS} are respectively the winding turns of the second primary winding N_{P2} and the secondary winding N_{S} of the transformer 30.
The V_{L12} is the voltage generated by the leakage inductor L₁₂. It is given by,

$$\begin{matrix}\frac{1}{2} \times {C}_{70} \times {V}_{L l2}^{2} = \frac{1}{2} \times {L}_{l2} \times {I}_{P}^{2} & ( 9 ) \\ {V}_{L l2} = \sqrt{\frac{{L}_{l2}}{{C}_{70}}} \times {I}_{P} & ( 10 )\end{matrix}$$

where C₇₀ is the capacitance of the supplied capacitor 70; L₁₂ is the inductance of the leakage inductor L₁₂.

Because the voltage V_{L12} generated by the leakage inductor L₁₂ causes the voltage V_{DD} on the supplied capacitor 70 is higher than the voltage reflected from the secondary winding N_{S} of the transformer 30. The rectifier 80 is thus switched on once the transistor 35 is switched off. Therefore, the output voltage V_{O} of the flyback power converter can be fed to the control circuit 100 through the second primary winding N_{P2}. By properly developing the leakage inductor L₁₂ of the second primary winding N_{P2} will improve the load regulation at light load and no load circumstances.

FIG. 4 shows the circuit diagram of the control circuit 100 that includes a supply terminal VDD and a ground terminal GND parallel connected to the supplied capacitor 70 for receiving power. The supply terminal VDD is connected to the diode 60. The ground terminal GND is connected to the second primary winding N_{P2}. A voltage detection terminal VS is coupled to the second primary winding N_{P2} through the divider 50 for detecting a detecting voltage V_{DET2} from the second primary winding N_{P2} of the transformer 30. The detecting voltage V_{DET2} can be expressed as,

$${V}_{DET 2} = \frac{{R}_{52}}{{R}_{52} + {R}_{55}} \times {V}_{NP 2} \qquad ( 11 )$$

where R₅₂ and R₅₅ are respectively the resistance of the resistors 52 and 55; V_{NP2} is the voltage of the second primary winding N_{P2}.

A current sense terminal VI is coupled to the current sense resistor 37 for receiving the current signal V_{CS}. An output terminal VG is coupled to an output terminal of a flip-flip 160 to generate the switching signal V_{PWM} for switching the transformer 30 via the transistor 35. An oscillator 150 generates a periodic pulse signal transmitted to a set terminal of the flip-flop 160. The periodic pulse signal is utilized to start the switching signal V_{PWM}. A comparator 125 is used to turn off the switching signal V_{PWM}. A negative input of the comparator 125 is connected to the current sense terminal VI to receive the current signal V_{CS}. A positive input of the comparator 125 is connected to an output terminal of an error amplifier 120 to receive a feedback signal V_{FB}.

Once the current signal V_{CS} is higher than the feedback signal V_{FB}, the switching signal V_{PWM} will be turned off. An output terminal of the comparator 125 is connected to a reset terminal of the flip-flip 160 to generate a reset signal V_{RST} transmitted to the reset terminal to turn off the switching signal V_{PWM}. The error amplifier 120 is utilized to generate the feedback signal V_{FB}. A positive input of the error amplifier 120 receives a reference voltage V_{R}. A negative input of the error amplifier 120 is connected to an output terminal of a sample-hold circuit 110 to receive a sample signal V_{S}. An input terminal of the sample-hold circuit 110 is coupled to the voltage detection terminal VS to detect the detecting voltage V_{DET2} from the transformer 30 via the divider 50 for generating the sample signal V_{S}. The output voltage V_{O} of the flyback power converter is therefore regulated.

$${V}_{O} + {V}_{F} = \frac{{N}_{NS}}{{N}_{NP 2}} \times {V}_{NP 2} \qquad ( 12 )$$

In accordance with equations (11) and (12), the output voltage V_{O} can be expressed as

$${V}_{O} = ( \frac{{R}_{52} + {R}_{55}}{{R}_{52}} \times \frac{{N}_{NS}}{{N}_{NP 2}} \times {V}_{DET 2} ) - {V}_{F} \qquad ( 13 )$$

According to present invention, the split primary winding of the transformer minimizes the inductance of the leakage inductor. Besides, the stored energy of the leakage inductor is used to provide power to the control circuit, which achieves better efficiency and improves the load regulation at light load and no load. Furthermore, the transistor is equipped in between the split windings of the transformer result a lower EMI.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A flyback power converter, comprising:
a transformer, transferring the energy from a primary side of the transformer to a secondary side of the transformer, wherein the transformer includes a first primary winding and a second primary winding, wherein the first primary winding and the second primary winding are coupled to a positive supply rail and a negative supply rail respectively;
a transistor, connected in between the first primary winding and the second primary winding for switching the transformer;
a control circuit, coupled to the transistor and the second primary winding to generate a switching signal for switching the transistor and regulating the output of the flyback power converter;
a supplied capacitor, connected to the control circuit to supply the power to the control circuit; and
a diode, coupled from the negative supply rail to the supplied capacitor for charging the supplied capacitor.

2. The flyback power converter as claimed in claim 1, further comprising a current sense device connected from the transistor to the second primary winding for generating a current signal in accordance with a switching current of the transformer, wherein the control circuit receives the current signal for generating the switching signal.

3. The flyback power converter as claimed in claim 1, wherein the second primary winding has a leakage inductor to store a stored energy when the transistor is turned on, wherein the stored energy of the leakage inductor is discharged to the supplied capacitor once the transistor is turned off.

4. The flyback power converter as claimed in claim 1, wherein the control circuit further comprising:
a supply terminal, connected to the supplied capacitor and the diode;
a ground terminal, connected to the supplied capacitor for receiving the power, wherein the ground terminal is connected to the second primary winding;
a voltage detection terminal, coupled to the second primary winding for detecting a voltage from the transformer;
a current sense terminal, coupled to the transistor for receiving a current signal; and
an output terminal, generating the switching signal to switch the transformer via the transistor in accordance with the voltage from the transformer and the current signal.

5. The flyback power converter as claimed in claim 4, wherein the control circuit further comprising:
a sample-hold circuit, coupled to the voltage detection terminal to detect the voltage from the transformer for generating a sample signal;
an error amplifier, coupled to the sample-hold circuit, wherein the error amplifier receives a reference voltage and the sample signal for generating a feedback signal;
a comparator, coupled to the error amplifier and the current sense terminal to receive the feedback signal and the current signal for generating a reset signal;
an oscillator, generating a periodic pulse signal; and
a flip-flip, coupled to the oscillator, the comparator and the output terminal for generating the switching signal, wherein the periodic pulse signal and the reset signal are used to start and turn off the switching signal respectively.

6. A flyback power converter, comprising:
a transformer, having a first primary winding and a second primary winding coupled to a supply rail of the flyback power converter;
a transistor, connected in between the first primary winding and the second primary winding for switching the transformer;
a control circuit, coupled to the transistor and the transformer to generate a switching signal for switching the transistor and regulating the output of the flyback power converter;
a supplied capacitor, connected to the control circuit; and
a diode, coupled from the transformer to the supplied capacitor for charging the supplied capacitor.

7. The flyback power converter as claimed in claim 6, further comprising a current sense device coupled to the transistor for generating a current signal in accordance with a switching current of the transformer, wherein the control circuit receives the current signal for generating the switching signal.

8. The flyback power converter as claimed in claim 6, wherein the transformer has a leakage inductor to store a stored energy when the transistor is turned on, wherein the stored energy of the leakage inductor is discharged to the supplied capacitor once the transistor is turned off.

9. The flyback power converter as claimed in claim 6, wherein the control circuit further comprising:
a supply terminal, connected to the supplied capacitor and the diode;
a ground terminal, connected to the supplied capacitor and the transformer;
a voltage detection terminal, coupled to the transformer for detecting a voltage from the transformer;
a current sense terminal, coupled to the transistor for receiving a current signal; and
an output terminal, generating the switching signal to switch the transformer via the transistor in accordance with the voltage from the transformer and the current signal.
